(19) United States
(12) Patent Application Publication
(10) Pub. No.: US 2010/0082663 A1
(43) Pub. Date: Apr. 1, 2010

(54) Method and System for Identifying Equivalent Digital Media Assets

(76) Inventors: Ricardo D. Cortes, Los Gatos, CA (US); George Campbell, Sunnyvale, CA (US); Michael S. Amirault, Campbell, CA (US); Sean K. Smith, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/238,315

(22) Filed: Sep. 25, 2008

(51) Int. Cl. G06F 7/06; G06F 17/30

(52) U.S. Cl. 707/769; 707/E17.014

(57) ABSTRACT

Improved management of digital media assets within an on-line media repository are disclosed. In one embodiment, the management includes methods and systems for identifying distinct digital media assets that are equivalent to one another. In one implementation, a plurality of digital media assets described and/or stored in a media storage device (e.g., database) can be automatically examined to determine whether any of them match one another or match a new digital media asset. Those digital media assets that are considered equivalent can be treated as such by an on-line store so as to facilitate customer interaction.

### BACKGROUND OF THE INVENTION

1. Field of the Invention

The present invention relates to digital media assets and, more particularly, to identification of digital media assets that are equivalent.

2. Description of the Related Art

On-line media repositories often store many digital media items, such as songs or videos. It is common for users to access on-line media repositories to purchase songs or videos on-line. The typical interaction with an on-line media repository is that a user will browse the on-line media repository, select one or more media items to be purchased or otherwise acquired, and then receive electronic delivery of the items over a network. One example of an on-line media repository is an on-line media store, such as the itunes Music Server® provided by Apple Inc.

However, as on-line media repositories continue to get larger, management of the numerous digital media items gets progressively more complicated. In particular, content providers that provide digital media items to an on-line media repository often submit multiple copies or versions at different times to the on-line media repository. Hence, while there may be some minor or subtle differences between the submitted copies or versions, a distribution system needs to understand the relationship of the copies or versions in order to operate in an effective and optimized manner.

Thus, there is a need for improved approaches to facilitate management of numerous digital media items within an on-line media repository.

### SUMMARY OF THE INVENTION

The invention pertains to improved management of digital media assets within an on-line media repository. In one embodiment, the management includes methods and systems for identifying distinct digital media assets that are equivalent to one another. In one implementation, a plurality of digital media assets described and/or stored in a media storage device (e.g., database) can be automatically examined to determine whether any of them match one another or match a new digital media asset. Those digital media assets that are considered equivalent can be treated as such by an on-line store so as to facilitate customer interaction.

In general, the invention can be implemented in numerous ways, including as a method, system, device, apparatus (including graphical user interface or computer readable medium). Several embodiments of the invention are discussed below.

As a computer-implemented method for identifying distinct digital media assets that can be considered equivalents, one embodiment of the invention can, for example, include at least: identifying a digital media asset to be processed, the digital media asset being stored in or destined for storage to a content database, the content database storing attributes and/or content data for a plurality of stored digital media assets; searching the content database for any stored digital media assets that are equivalent to the identified digital media asset; determining whether the searching has found at least one stored digital media asset that is equivalent to the identified digital media asset; and storing equivalency information in the content database if it is determined that the searching has found at least one stored digital media asset that is equivalent to the identified digital media asset.

As a computer-implemented method for identifying distinct playlists of digital media assets that can be considered equivalents, one embodiment of the invention can, for example, include at least: identifying a plurality of playlists described and/or stored in a content database; categorizing each of the identified playlists into one of a plurality of categories; selecting one of the categorized playlists to be processed; determining whether a type of matching to be performed with respect to the selected one of the categorized playlists; and searching the content database for at least one matching playlist in accordance with the determined type of matching.

As a computer-implemented method for identifying distinct playlists of digital media assets that can be considered equivalents, another embodiment of the invention can, for example, include at least: identifying a plurality of playlists of a particular content provider; categorizing each of the identified playlists into one of a plurality of categories; selecting one of the categorized playlists to be processed; searching the content database for at least one matching playlist to the selected playlist; denoting the at least one matching playlist as equivalent to the selected playlist; searching songs within the selected playlist and songs within the at least one matching playlist to identify matching songs therebetween; and denoting the matching songs as equivalent.

As a computer readable medium including at least executable computer program code stored thereon for identifying distinct digital media assets that can be considered equivalents, one embodiment of the invention includes at least: computer program code for identifying a digital media asset to be processed, the digital media asset being stored in or destined for storage to a content database, the content database describing and/or storing a plurality of stored digital media assets; computer program code for searching the content database for any stored digital media assets that are equivalent to the identified digital media asset; computer program code for determining whether the computer program code for searching has found at least one stored digital media asset that is equivalent to the identified digital media asset; and computer program code for storing equivalency information in the content database if it is determined that the computer program code for searching has found at least one stored digital media asset that is equivalent to the identified digital media asset. Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media distribution system according to one embodiment of the invention.

FIG. 2 is a flow diagram of an equivalency process according to one embodiment of the invention.

FIG. 3 is a flow diagram of an asset matching process according to one embodiment of the invention.

FIGS. 4A and 4B are flow diagrams of a playlist matching process according to one embodiment of the invention.

FIGS. 5A and 5B are flow diagrams of a playlist and song matching process according to one embodiment of the invention.

### DETAILED DESCRIPTION OF THE INVENTION

The invention pertains to improved management of digital media assets within an on-line media repository. In one embodiment, the management includes methods and systems for identifying distinct digital media assets that are equivalent to one another. In one implementation, a plurality of digital media assets described and/or stored in a media storage device (e.g., database) can be automatically examined to determine whether any of them match one another or match a new digital media asset.

Those digital media assets that are considered equivalent can be treated as such by an on-line store so as to facilitate customer interaction. As one example, in some cases, digital media assets that have similar content can be considered equivalents. For instance, a content provider might submit a digital media assets in a clean form and an explicit form. Hence, even though the digital media assets are different, they can be considered equivalents at least for some purposes. An improved customer interaction can be obtained by being able to offer customers interested in a particular digital media asset both clean and explicit versions in an automated fashion. As another example, through an understanding of equivalency mappings between distinct digital media assets, additional upgrade opportunities can be made available to customer of an on-line store. For additional details on providing upgrade opportunities, see U.S. patent application Ser. Nos. 12/028,521; 11/685,098; and 11/561,336, each of which is hereby incorporated herein for all purposes. As still another example, equivalency mappings between distinct digital media assets can be use to enable customers to create ringtones even when the digital media asset they previously purchased is no longer supported because a more recent version does permit ringtone creation. For additional details on creating or providing ringtones, see U.S. patent application Ser. Nos. 11/849,975; 11/767,418; and 11/650,858, each of which is hereby incorporated herein for all purposes.

The digital media assets can be audio, graphic, video, or some combination thereof. A set of digital media items is a group of digital media assets. A set of digital media assets can, for example, pertain to a group, collection, playlist, or bundle of digital media assets. As examples, a set of digital media assets can pertain to an album (i.e., a set of songs), a television series or season (i.e., a set of television shows/episodes), a photo album (i.e., a set of photos or images), a video album (i.e., a set of videos)(e.g., movies or music videos), or a set of podcasts (i.e., a set of podcast episodes). A set of digital media assets can also include or be supplemented by text or multimedia files.

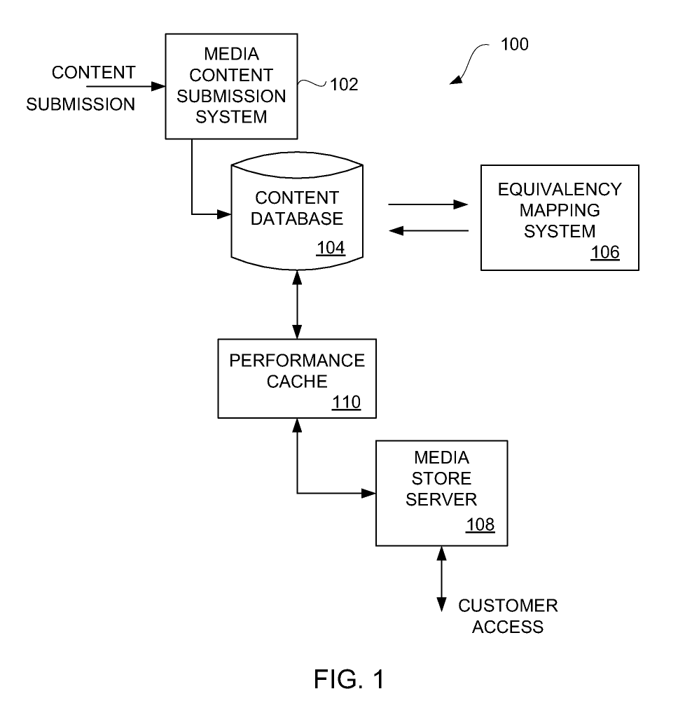

Embodiments of the invention are discussed below with reference to FIGS. 1-5B. However, those skilled in the art will readily appreciate that the detailed description given herein with respect to these figures is for explanatory purposes as the invention extends beyond these limited embodiments.

FIG. 1 is a block diagram of a media distribution system 100 according to one embodiment of the invention. The media distribution system 100 includes a media content submission system 102. Content providers can submit content to the media content submission system 102. In one implementation, the media content submission system 102 is coupled to a public network, such as the Internet, and content providers can electronically submit media content to the media submission system 102 via the public network. The media content can, for example, pertains to music (e.g., songs or albums) or video (e.g., movies or television shows).

The media distribution system 100 also includes a content database 104. The content database 104 operates as a media content repository for a plurality of different media items that are available for distribution by the media distribution system 100. Within the content database 104, each of the different media items can be characterized, such as with metadata or other data to describe attributes of the media items. The content data itself can be stored within the content database 104 or in a separate data storage device (not shown) also provided by or coupled to the media distribution system 100.

The media distribution system 100 also includes an equivalency mapping system 106. The equivalency mapping system 106 can interact with the content database 104 to identify digital media items that are equivalent to one another. By using computer-implemented techniques to determine which digital media items are equivalent to one another, the media distribution system 100 can operate with greater efficiency and productivity.

The media distribution system 100 can be associated with a media store server 108. The media store server 108 can host an on-line store where the digital media items within the content database 104 can be made available for purchase and/or distribution. The media store server 108 can coupled to the content database 104 by way of a performance cache 110. The performance cache 110 represents a configuration of at least a subset of the data within the content database 104 so that such content can be efficiently accessed by the media store server 108. Customers can access the on-line store hosted by the media store server 108 via a public network, such as the Internet. By use of the equivalency mappings, the media distribution system 100, in particular the operation of the media store server 108, can provide users with an improved user experience. The improved user experience can, for example, facilitate providing customers with additional upgrade opportunities, more ringtone creation permission, and the like.

Content providers often redeliver media content to the media distribution system 100 via the media content submission system 102. In doing so, the content database 104 tends to store duplicates in terms of content. The redelivered media content can also from a different content provider (vendor) (e.g., different vendor identifier), though the content provider is typically related to the original content provider in some manner (e.g., via an affiliate, related entity, or merger/acquisition). The same media content can also be delivered at different quality levels, such as 128-bit encoding and 256-bit encoding. In one embodiment, the same media content at different quality levels can also be considered equivalents.

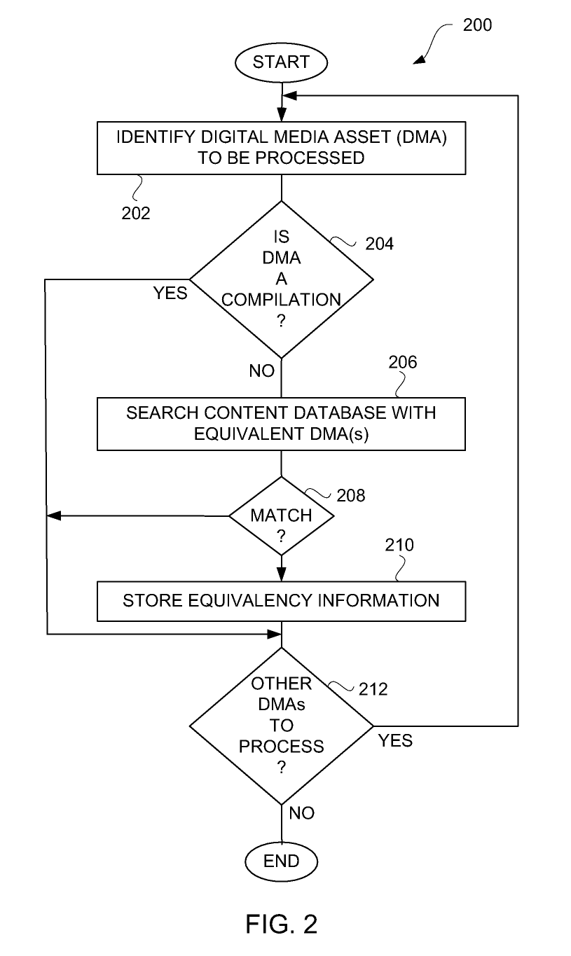

FIG. 2 is a flow diagram of an equivalency process 200 according to one embodiment of the invention. The equivalency process 200 can, for example, be performed by the equivalency mapping system 106 illustrated in FIG. 1.

In the equivalency process 200, a digital media asset (DMA) to be processed can be identified 202. A decision 204 can then determine whether the identified digital media asset is a compilation. A compilation is a type of digital media asset in which multiple different artists participate to the content provided within the compilation. For example, a compilation can be a digital media asset, such as a playlist, that has for each individual digital media asset in the playlist a common primary artist. When the decision 204 determines that the identified digital media asset is not a compilation, the content database, such as the content database 104, can be searched 206 for equivalent digital media assets. A decision 208 can then determine whether one or more digital media assets (equivalent digital media assets) in the content database have been determined to match. When the decision 208 determines that a match has been found for the identified digital media asset, equivalency information can be stored 210. For example, the equivalency information can be stored 210 to the content database. On the other hand, when the decision 208 determines that no digital media assets have been determined to match, the block 210 can be bypassed. Following the block 210, or its being bypassed, a decision 212 can determine whether there are other digital media assets are to be processed. Similarly, when the decision 204 determines that the identified digital media asset is a compilation, the equivalency process 200 continues at the decision 212 and, in this embodiment, not suitable for equivalency processing. When the decision 212 determines that there are other digital media assets to process, the equivalency process 200 returns to repeat the block 202 so that another digital media asset can be identified and similarly processed. Alternatively, when the decision 212 determines that there are no other digital media assets to be processed, the equivalency process 200 can end.

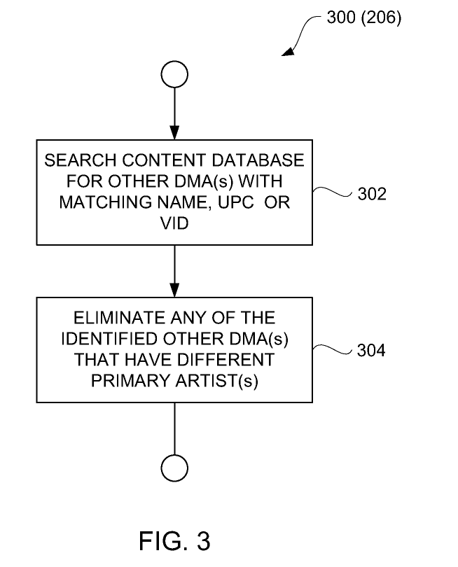

FIG. 3 is a flow diagram of an asset matching process 300 according to one embodiment of the invention. The asset matching process 300 is, for example, processing suitable for the block 206 of the equivalency process 200 illustrated in FIG. 2.

The asset matching process 300 can initially search 302 the content database for other Digital Media Assets (DMAs) that have a matching name (or title), Universal Product Code (UPC) or Vendor Identifier (VID). Next, any of the identified other digital media assets that have different primary artists can be eliminated 304. Hence, from the other digital media assets that have been identified as possibly equivalent, those of the other digital media assets that have different primary artists can be eliminated 304 as not being equivalent. Following the block 304, the asset matching process 300 can end.

The asset matching process 300 represents one embodiment of a matching process suitable for use in discovering equivalent digital media assets. In particular, the asset matching process 300 is well suited for discovering digital media assets, such as playlists, that have been redelivered to a media distribution system yet are equivalent to previously submitted digital media assets. However, it should be understood that other matching processes may be used to discover equivalent digital media assets.

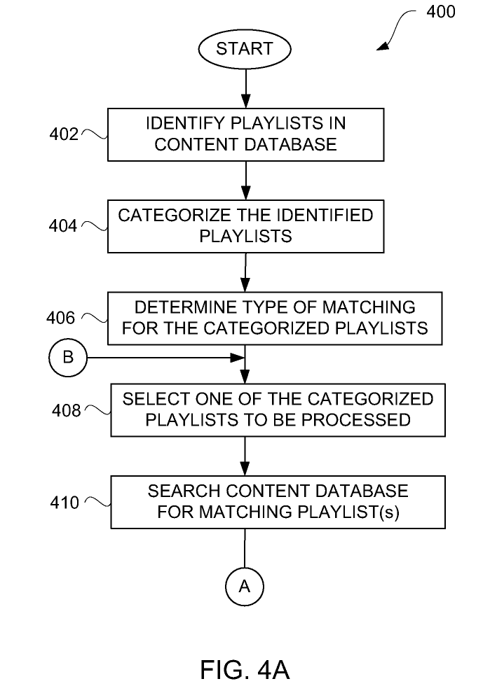

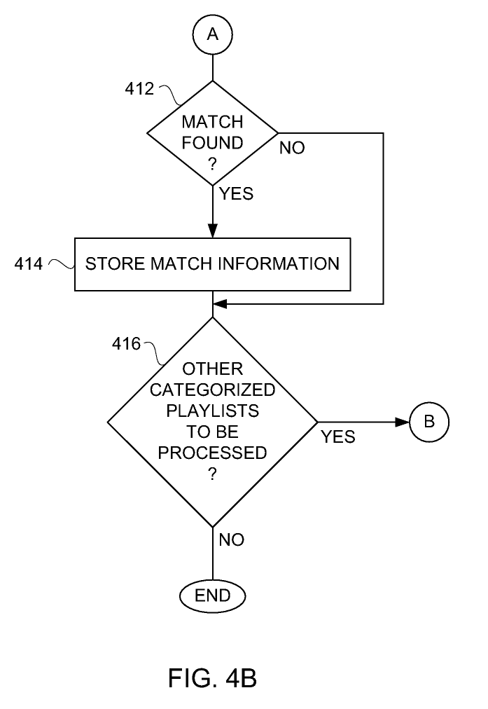

FIGS. 4A and 4B are flow diagrams of a playlist matching process 400 according to one embodiment of the invention. The playlist matching process 400 can, for example, be performed by the equivalency mapping system 106 together with the content database 104 of the media distribution system 100 illustrated in FIG. 1.

The playlist matching process 400 identifies 402 playlists in a content database. For example, the content database 104 can store a plurality of playlists that can be identified 402. The identified playlists can then be categorized 404. In one embodiment, the playlists (e.g., albums) can be placed in one of a plurality of categories. For example, the playlist categories can include standard, deluxe, EP and single. Next, the type of matching to be carried out for that categorized playlists can be determined 406. In one embodiment, different matching processing can be performed for different categories of playlists. In another embodiment, one or more categories of playlists might also be ineligible for any match processing.

Next, one of the categorized playlists is selected 408 to be processed. Assuming the categorized playlist is eligible for match processing, the content database can be searched 410 for one or more matching playlists. In one embodiment, the searching 410 can use the asset matching process 300 illustrated in FIG. 3. In another embodiment, the searching 410 can use a plurality of different asset matching processes, any of which can be used to locate a matching playlist. In still another embodiment, the one or more different asset matching processes that are used for the searching 410 can be dependent on the categorization of the categorized playlist.

Following the block 410, a decision 412 can determine whether the searching 410 being performed has found a match. When the decision 412 determines that the searching being performed has found a match, match information pertaining to the match can be stored 414. In one implementation, the matching information can be stored 414 in the content database. On the other hand, when the decision 412 determines that the searching being performed has not found a match, the block 414 is bypassed. Following the block 414, or its being bypassed, a decision 416 can determine whether other categorized playlists are to be processed. When the decision 416 determines that there are other categorized playlists to be processed, the playlist matching process 400 can return to repeat the block 408 so that another one of the categorized playlists can be selected and similarly processed. Alternatively, when the decision 416 determines that there are no other categorized playlists to be processed, the playlist matching process 400 can end.

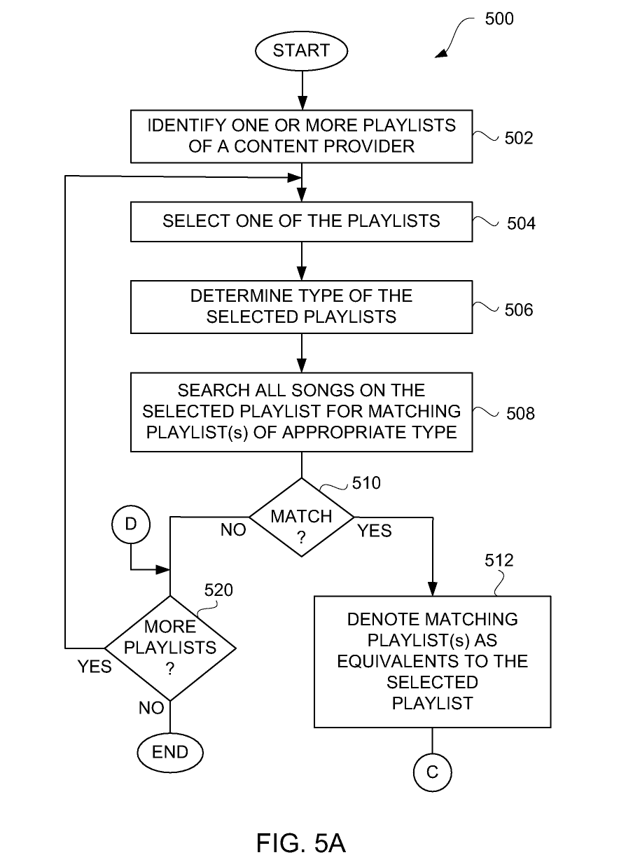

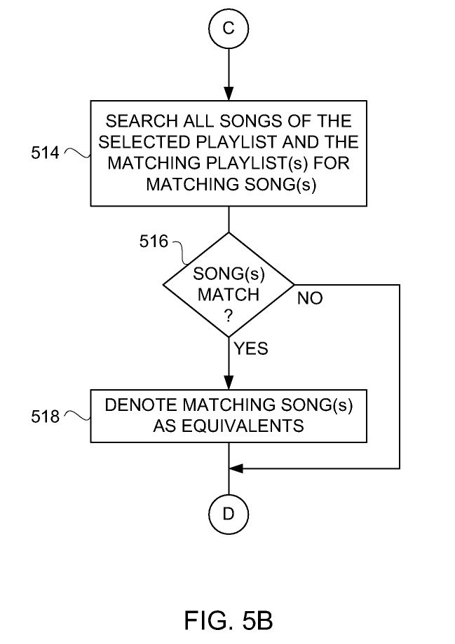

FIGS. 5A and 5B are flow diagrams of a playlist and song matching process 500 according to one embodiment of the invention. The playlist and song matching process 500 can, for example, be performed by the equivalency mapping system 106 together with the content database 104 of the media distribution system 100 and illustrated in FIG. 1.

The playlist and song matching process 500 identifies 502 one or more playlists of a content provider. Here, the content provider is a particular provider of media content. As an example, a content provider can refer to a music label or a video label. However, a content provider can have various affiliated (or related) companies or organizations that although have different names (and different vendor identifiers) can be deemed to equate to the same content provider. One of the playlists that has been identified can then be selected 504 for processing. A type of the selected playlist can be determined 506. The type can pertain to a categorization for the selected playlist. As an example, the type can one of EP, single, deluxe or standard, which are categories of playlists (e.g., albums). Thereafter, all songs on the selected playlist are searched 508 for matching playlists of an appropriate type. For example, depending on the type of the selected playlists, the matching playlist can be limited to only certain types, or even the same type.

Following the blocks 508, a decision 510 determines whether one or more matches to the selected playlist has been found by the searching 508. When the decision 510 determines that one or more matches for the selected playlist have been found, the one or more matching playlists can be denoted 512 as equivalents to the selected playlist. In addition, all songs (or videos) of the selected playlist and the one or more matching playlists can be searched 514 for matching songs. Here, the selected playlist has one or more songs and each of the matching playlists have one or more songs. Accordingly, at block 514, the songs between the selected playlist and each of the matching playlists can be compared to identify those songs that are equivalent to each other. The song-based matching by the searching 514 can be based on criteria, such as chosen from the following, which can be used as song-equivalency tests: (i) International Standard Recording Code (ISRC) matching; (ii) Vendor Identifier and Content Provider matching; (iii) ISRC and Track/Disc number; (iv) Vendor Identifier, Content Provider and Track/Disc number; (v) Name and Track/Disc number; and Name, Duration and Artist. Alternatively, if the selected playlist and the one or more matching playlists contain videos, the searching 514 can additionally or alternatively search for matching videos using a generally similar approach.

A decision 516 can then determine whether one or more of the songs within the selected playlist match the one or more songs in the matching playlist. When the decision 516 determines that one or more of the songs do match, the matching one or more songs can be denoted 518 as equivalent. Alternatively, when the decision 516 determines that there are no matching songs, the block 518 is bypassed. Following the block 518, or its being bypassed, the playlist and song matching process 500 can perform a decision 520. The decision 520 determines whether there are more playlists to be processed. The decision 520 is also performed when the decision 510 determines that there are no matching playlists to the selected playlist in the content database. In any case, when the decision 520 determines that there are more playlists to be processed, the playlist and song matching process 500 can return to repeat the block 504 so that another one of the playlists can be selected and similarly processed. On the other hand, when the decision 520 determines that there are no more playlists to be processed, the playlist and song matching process 500 can end.

The following items are hereby incorporated herein by reference: (i) U.S. patent application Ser. No. 12/028,521, filed Feb. 8, 2008, and entitled “METHOD AND SYSTEM FOR UPGRADING A PREVIOUSLY PURCHASED MEDIA ASSET;” (ii) U.S. patent application Ser. No. 11/685,098, filed Mar. 12, 2007, and entitled “METHOD AND SYSTEM FOR UPGRADING A PREVIOUSLY PURCHASED MEDIA ASSET;” (iii) U.S. patent application Ser. No. 11/561,336, filed Nov. 17, 2006, and entitled “METHOD AND SYSTEM FOR UPGRADING A PREVIOUSLY PURCHASED MEDIA ASSET;” (iv) U.S. patent application Ser. No. 11/247,948, filed Oct. 10, 2005, and entitled “ON-LINE MEDIA STORE THAT SUPPORTS PRE-ORDERING OF DIGITAL MEDIA ASSETS;” (v) U.S. patent application Ser. No. 11/212,314, filed Aug. 24, 2005, and entitled “ON-LINE MEDIA STORE THAT SUPPORTS PRE-ORDERING OF DIGITAL MEDIA ASSETS;” (vi) U.S. patent application Ser. No. 10/833,267, filed Apr. 26, 2004, and entitled “METHOD AND SYSTEM FOR NETWORK-BASED PURCHASE AND DISTRIBUTION OF MEDIA;” and (vii) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION.”

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The advantages of the invention are numerous. Different embodiments or implementations may, but need not, yield one or more of the following advantages. One advantage of certain embodiments of the invention is that equivalent digital media assets can be located in an automated and reliable way. Another advantage of certain embodiments of the invention is that equivalencies between playlists can be determined in accordance with one or more equivalency rules. Another advantage of certain embodiments of the invention is that customer experiences with on-line media stores can be improved when the on-line media stores understand equivalencies present in their stored digital media assets. Still another advantage of certain embodiments of the invention is that once equivalencies are known, one digital media asset can be substituted for another in appropriate situations. For example, established equivalencies can be used to relate earlier purchased digital media assets that are no longer available to now available digital media assets. The substitution can be actual substitution of media content or can be merely permission or rights substitution (e.g., right to produce a ringtone).

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for identifying distinct digital media assets that can be considered equivalents, said method comprising:
identifying a digital media asset to be processed, the digital media asset being stored in or destined for storage to a content database, the content database storing attributes and/or content data for a plurality of stored digital media assets;
searching the content database for any stored digital media assets that are equivalent to the identified digital media asset;
determining whether said searching has found at least one stored digital media asset that is equivalent to the identified digital media asset; and
storing equivalency information in the content database if said determining determines that said searching has found at least one stored digital media asset that is equivalent to the identified digital media asset.

2. A computer-implemented method as recited in claim 1, wherein the equivalency information is an equivalency relationship between the identified digital media asset and the at least one stored digital media asset.

3. A computer-implemented method as recited in claim 1,
wherein the identified digital media asset has a name, one or more primary artists and a unique identifier, and
wherein said searching is performed in accordance with at least one equivalency rule.

4. A computer-implemented method as recited in claim 3, wherein the at least one equivalency rule requires that (i) the name or the unique identifier of the at least one stored digital media asset match the name or the unique identifier for the identified digital media asset, and (ii) the primary one or more artists of the at least one stored digital media asset match the primary one or more artists for the identified digital media asset.

5. A computer-implemented method as recited in claim 4, wherein the unique identifier is a numerical or alphanumerical identifier.

6. A computer-implemented method as recited in claim 4, wherein the unique identifier is a Universal Product Code (UPC) or Vender Identifier (VID).

7. A computer-implemented method as recited in claim 1, wherein the identified digital media asset and the at least one stored digital media asset are playlists that include digital media assets.

8. A computer-implemented method for identifying distinct playlists of digital media assets that can be considered equivalents, said method comprising:
identifying a plurality of playlists described and/or stored in a content database;
categorizing each of the identified playlists into one of a plurality of categories;
selecting one of the categorized playlists to be processed;
determining whether a type of matching to be performed with respect to the selected one of the categorized playlists; and
searching the content database for at least one matching playlist in accordance with the determined type of matching.

9. A computer-implemented method as recited in claim 8, wherein the type of matching to be performed is dependent on the categorization of the identified playlists.

10. A computer-implemented method as recited in claim 8,
wherein the selected one of the categorized playlists has a name, one or more primary artists and a unique identifier, and
wherein the type of matching to be performed uses at least a first matching rule, the first matching rule requires that (i) the name or the unique identifier of the at least one matching playlist match the name or the unique identifier for the selected one of the categorized playlists, and (ii) the one or more primary artists of the at least one matching playlist match the one or more primary artists for the selected one of the categorized playlists.

11. A computer-implemented method as recited in claim 10, wherein the selected one of the categorized playlists has a plurality of songs, and each of the songs has song descriptive information.

12. A computer-implemented method as recited in claim 8, wherein said method further comprises:
storing match information for the at least one matching playlist in the content database.

13. A computer-implemented method for identifying distinct playlists of digital media assets that can be considered equivalents, said method comprising:
identifying a plurality of playlists of a particular content provider;
categorizing each of the identified playlists into one of a plurality of categories;
selecting one of the categorized playlists to be processed;
searching the content database for at least one matching playlist to the selected playlist;
denoting the at least one matching playlist as equivalent to the selected playlist;
searching songs within the selected playlist and songs within the at least one matching playlist to identify matching songs therebetween; and
denoting the matching songs as equivalent.

14. A computer-implemented method as recited in claim 13, wherein said denoting the matching songs as equivalent comprises:
storing a match indication in the content database for those of the matching songs.

15. A computer-implemented method as recited in claim 13, wherein the categories include EP, single, deluxe or standard.

16. A computer-implemented method as recited in claim 13, wherein said searching of the content database for at least one matching playlist to the selected playlist comprises:
searching the content database for at least one matching playlist in accordance with a first matching rule if the selected playlist has a first type of category; and
searching the content database for at least one matching playlist in accordance with a second matching rule if the selected playlist has a second type of category.

17. A computer-implemented method as recited in claim 13, wherein the particular content provider includes a plurality of closely related content providers.

18. A computer readable medium including at least executable computer program code stored thereon for identifying distinct digital media assets that can be considered equivalents, said computer readable medium comprising:
computer program code for identifying a digital media asset to be processed, the digital media asset being stored in or destined for storage to a content database, the content database describing and/or storing a plurality of stored digital media assets;
computer program code for searching the content database for any stored digital media assets that are equivalent to the identified digital media asset;
computer program code for determining whether said computer program code for searching has found at least one stored digital media asset that is equivalent to the identified digital media asset; and
computer program code for storing equivalency information in the content database if said computer program code for determining determines that said computer program code for searching has found at least one stored digital media asset that is equivalent to the identified digital media asset.
